(19) United States
(12) Patent Application Publication
(10) Pub. No.: US 2025/0133469 A1
(43) Pub. Date: Apr. 24, 2025

(54) USING MACHINE LEARNING MODELS TO GENERATE CONNECTIVITY GRAPHS BETWEEN DEVICE AND NETWORK NODES FOR USE IN CONDITIONAL HANDOVER PROCEDURES

(71) Applicant: Telefonaktiebolaget LM Ericsson (publ), Stockholm (SE)

(72) Inventors: Selim ICKIN, Danderyd (SE); Jalil TAGHIA, Stockholm (SE)

(21) Appl. No.: 18/836,497

(22) PCT Filed: Feb. 8, 2022
(86) PCT No.: PCT/SE2022/050135

§ 371 Date: Aug. 7, 2024

(51) Int. Cl. H04W 36/36; H04L 41/16

(52) U.S. Cl. CPC H04W 36/362; H04L 41/16

(57) ABSTRACT

The disclosed aspects relate to the use of distributed machine learning models in conditional handover procedures. There is provided a method for a distributed machine learning assisted conditional handover procedure for a connected device, the method including receiving, by the connected device, one or more measurement configurations from a source station; transmitting, by the connected device, one or more measurement reports to the source station; receiving and storing, by the connected device, one or more CHO commands from the source station, the one or more CHO commands having at least one triggering condition for CHO to one or more candidate target cells, wherein the one or more CHO commands are determined by inputting the one or more measurement reports into a distributed ML-generated reference model; and evaluating, by the connected device, whether the at least one triggering

### TECHNICAL FIELD

The field relates generally to using distributed machine learning models to improve conditional handover (CHO) procedures. More specifically, the field relates to generating connectivity graphs using distributed machine learning (ML) models for use in CHO procedures. Disclosed are aspects related to generating connectivity graphs between device and network nodes for use in CHO procedures.

### BACKGROUND

### Machine Learning and Federated Learning

In the past few years, machine learning has led to major breakthroughs in various areas, such as natural language processing, computer vision, speech recognition, and Internet of Things (IoT), with some breakthroughs related to automation and digitalization tasks. Machine learning can also be applied to the field of telecommunications. Most of this success stems from collecting and processing big data in suitable environments. For some applications of machine learning, this process of collecting data can be incredibly privacy invasive. One potential use case is to improve the results of speech recognition and language translation, while another one is to predict the next word typed on a mobile phone to increase the speed and productivity of the person typing. Another potential use case is predicting when a connected device needs to handover from one network to another before the connected device loses connectivity to its current network. In all cases, it would be beneficial to directly train on the same data instead of using data from other sources. This would allow for training a machine learning (ML) model (referred to herein as “model” also) on the same data distribution (i.i.d.—independent and identically distributed) that is also used for making predictions. However, directly collecting such data might not always be feasible owing to privacy concerns. Users may not prefer nor have any interest in sending everything they type to a remote server/cloud.

One recent solution to address this is the introduction of federated learning, a new distributed machine learning approach where the training data does not leave the users' computing device at all. Instead of sharing their data directly, the client computing devices themselves compute weight updates using their locally available data. It is a way of training a model without directly inspecting clients' or users' data on a server node or computing device. Federated learning is a collaborative form of machine learning where the training process is distributed among many users. A server node or computing device has the role of coordinating between models, but most of the work is not performed by a central entity anymore but by a federation of users or clients.

After the model is initialized in every user or client computing device, a certain number of devices are randomly selected to improve the model. Each sampled user or client computing device receives the current model from the server node or computing device and uses its locally available data to compute a model update. All these updates are sent back to the server node or computing device where they are averaged, weighted by the number of training examples that the clients used. The server node or computing device then applies this update to the model, typically by using some form of gradient descent.

Current machine learning approaches require the availability of large datasets, which are usually created by collecting huge amounts of data from user or client computing devices. Federated learning is a more flexible technique that allows training a model without directly seeing the data. Although the machine learning process is used in a distributed way, federated learning is quite different to the way conventional machine learning is used in data centers. The local data used in federated learning may not have the same guarantees about data distributions as in traditional machine learning processes, and communication is oftentimes slow and unstable between the local users or client computing devices and the server node or computing device. To be able to perform federated learning efficiently, proper optimization processes need to be adapted within each user machine or computing device. For instance, different telecommunications operators will each generate huge alarm datasets and relevant features. In this situation, there may be a good list of false alarms compared to the list of true alarms. For such a machine learning classification task, typically, the dataset of all operators in a central hub/repository would be required beforehand. This is required since different operators will encompass a variety of features, and the resultant model will learn their characteristics. However, this scenario is extremely impractical in real-time since it requires multiple regulatory and geographical permissions; and, moreover, it is extremely privacy-invasive for the operators. The operators often will not want to share their customers' data out of their premises. Hence, distribute machine learning, such as federated learning, may provide a suitable alternative that can be leveraged to greater benefit in such circumstances.

### Handover (HO) Mechanism

Handover occurs when a connected device (such as a cell phone) or user equipment (UE) switches its connection from one network such as a cell tower or other terrestrial network (TN) to another such as a non-terrestrial network (NTN) such as a satellite. In a stationary context, the HO decision might not be tricky. However, if both the serving cell and the UE is non-stationary and moving at high speeds (such as a satellite), forecasting and then optimizing a set of HO parameters in advance is critical to the success of HO.

There is a tradeoff for UE being connected to non-terrestrial network (NTN) or terrestrial network (TN). On one hand, the cost of UE being connected to TN is less, for example less UE energy consumption, as compared to being connected to NTN. On the other hand, once hand-in (NTN->TN HO) happens due to short sighted decisions especially in rural areas, there is a risk for UE losing connectivity to TN after some time in the case of high mobility due to TN's limited coverage area as compared to NTN. In addition, there is a risk that the TN network gets overloaded or might serve UE with poor quality of experience (QoE) given a particular service (such as broadband video streaming) at particular time of the day (e.g., busy hour). This then yields a tradeoff between the NTN's serving cost and end-user QoE.

Therefore, there exists a need for a UE being connected to NTN, where the UE should have a smart and pro-active HO control mechanism that decides whether or not to handover to TN based on its forecasted trajectory and UE context in the future, given that connecting back from TN to NTN would be hard as the connection of UE to the satellite was lost before. When to hand-in (NTN to TN) should be decided carefully with good forecasting of the future UE and network state in advance.

FIG. 1 is a sequence diagram, from E. Juan, M. Lauridsen, J. Wigard and P. E. Mogensen, “5G New Radio Mobility Performance in LEO-based Non-Terrestrial Networks,” 2020 IEEE Globecom Workshops (GC Wkshps, 2020, pp. 1-6), illustrating a conventional handover (HO) procedure 100 between a source 102 and target cell 104. The existing 5G new radio handover (HO) algorithm fails to provide seamless connectivity in low earth orbit based satellites (600 km-1200 km). The major reason for this is that the handover takes too long. The reason for long handover is that the propagation distance is orders of magnitude longer than the cell size hindering the user equipment (UE) 106 measurement. High propagation distance causes delay in control messages and outdated UE 106 measurements. The high distance (coverage area) also yields low signal variation between the cell center and the cell edge. There is also a high downlink interference from adjacent satellite beams. There is fast signal fading as a consequence of the high speed cell mobility and the narrow antenna pattern. This is in contrast to the omni-antennas in terrestrial network nodes. For non-terrestrial network (NTN) UE's, UE antenna are omni-directional for terrestrial network (TN), and unidirectional and narrow for NTN (directed to each beam in NTN). The HO time depends on the fact that if the HO is occurring between the cells of the same satellite or amongst different satellites. For example, HO decision is given if RSRP from one cell is HOM dB better than the other cell for TTT seconds. Conditional Handover (CHO) Mechanism

In earlier releases than 5G, the handover (HO) command was triggered after a user equipment (UE) reports an A3 event indicating that a UE reference signal received power (RSRP) on the serving cell is getting worse than the UE RSRP at a neighboring cell. However, it is sometimes too late to HO after sending the report since the quality can be too bad to send the report or the HO commands. In 5G new radio (NR), there are ways to cope with late HO that eventually causes radio link failure (RLF) and HO failure such as conditional HO (TS 38.331, TS 38.423). In conditional HO, the handover command is sent from the network to the UE in advance (based on previous measurement reports). Along with the early HO command, a list of candidate neighboring cell names are also sent. Both HO command and the list of candidate neighboring cells are stored in the UE. The UE does not perform HO immediately, but triggers the HO command only when the certain criteria is met (such as threshold delta between source and any target cell). The candidate neighboring cells received from the network should also be neither too large (otherwise might unnecessarily allocate resources in other cells, especially high load ones, during HO preparation), nor too small (not to reduce the risk of coverage and RLF).

Therefore, there exists a need to combine all the features in a machine-learning (ML) model so that a right planning for the HO control can be given in advance since there are massive number of input parameters and conditions (i.e., priors) to consider in the evaluation which might be hard to accomplish with rule based systems. There further exists a need to incorporate federated or distributed learning into this machine-learning model.

### SUMMARY

The method and device disclosed herein is not a replacement for existing conditional HO mechanism, but rather to improve it with more holistic view (obtained via collaborative learning with considerations of much more attributes and dimensions) and help CHO (conditional handover) to associate with optimum decision thresholds. This is especially important since in the CHO, there is a tradeoff between energy consumption and HO failure. The current implementation of CHO is mainly to reduce the risk of HO failure with the cost of allocating and preparing more target cells for the handover, and it might be that the suboptimal preparations in advance might allocate unnecessary resources such as increased energy consumption and increased QoS resource allocation on the target cells.

The HO alternatives are sent from TN to UE in the form of a graph representation, where the nodes in the graph are alternative network nodes where the HO can be made to, and the link between the nodes indicate the ranking with respect to the estimated overall quality if the HO is made to the corresponding target network.

The ML based collaborative method disclosed herein reduces the NTN HO mechanism decision with long and short term predictions. The goal is to minimize the UE's handover failure that occurs during HO from/to NTN.

The method disclosed herein includes cascaded/hierarchically structured KPI and UE context prediction models. The output of the final prediction model is fed into a Graph Neural Network to generate and recommend the graph structure given the predicted state of the network. The generated graph represents the connectivity of UE to the network which would yield minimum HO failure to/from NTN network and reduce cost by extending the connectivity time of the UE to TN if the UE is not expected to need NTN. As the structure of the generated graph can be similar in different time and location, the method disclosed herein includes a collaborative machine learning method on top of it to enable the generative and the prediction models to share weights in between each other. This necessitates a grouping of similar models before each model joins the training.

In some aspects disclosed herein, the goal is to generate the best connectivity graph between the UE and the network provider nodes (NTN and TN) to minimize the energy consumption and handovers and to maximize the objective QoE (derived from pre-trained model). The method and device disclosed herein considers the existing HO mechanisms such as conditional HO(CHO), and enhances it with a data-driven decision.

The method and device disclosed herein provides several advantages, including but not limited to: preventing the UE from going into a disconnected state due to handover failure or radio link failure; preventing the UE from being out of coverage by a proactive handover decision; reducing the cost of serving by minimizing the serving time from NTN; and reducing the energy consumption by reducing the number of handovers.

Internet of Things (IoT) Connectivity Management Use Case

In some cases an IoT device drops connectivity from a source cell before reestablishing on a new base station target cell; followed by the fact the device cannot establish a connectivity with the target cell. In the worst case, the scenario the IoT device completely loses connectivity and cannot connect, and is pushed into a dead-lock. In UE's this is not a problem since the human user can initiate a restart or can move close to one base station when the phenomena is experienced to trigger reconnection. But for remote stationary, IoT devices it is harder to do unless there is an auto-reboot mechanism (watch-dog timer) implementation in place.

The factors such as environmental, the traffic load of the candidate base stations are critical to the HO decision as they cause high interference. One example is the foliage, e.g., IoT sensors installed within a large forest area for early fire detection. Another example could be the geographical areas with river and large water damps, as well as heavy rainfall scenarios in a monsoon season climate. These factors can create additional interference that impacts measurement reports observed in the UE's in the area that might eventually cause HO failures.

In a first aspect, a method for a distributed machine learning (ML) assisted conditional handover (CHO) procedure for a connected device is provided. The method comprises receiving, by the connected device, one or more measurement configurations from a source station; transmitting, by the connected device, one or more measurement reports to the source station; receiving and storing, by the connected device, one or more CHO commands from the source station, the one or more CHO commands having at least one triggering condition for CHO to one or more candidate target cells, wherein the one or more CHO commands are determined by inputting the one or more measurement reports into a distributed ML-generated reference model; and evaluating, by the connected device, whether the at least one triggering condition in any of the one or more CHO commands is fulfilled.

In some aspects, the method further comprises executing, by the connected device, a decision for handover based on the evaluation, wherein the connected device executes the handover if the one or more CHO commands is fulfilled and does not execute the handover if the one or more CHO commands is not fulfilled.

In some aspects, the distributed ML-generated reference model is generated by: collecting data for a set of device and network node agents, wherein the collected data include attribute information for at least one connected device used for training, attribute information for at least one non-terrestrial network (NTN), and attribute information for at least one terrestrial network (TN); building, using the attribute information from the collected data, dependency graphs representing interaction relationships between the set of device and network node agents; constructing, using the dependency graphs, graph-based ML models representing profiles for the set of device and network node agents, wherein constructing the graph-based ML models includes generating connectivity between the set of device and network node agents; and training and validating the graph-based ML models using the generated connectivity for the set of device and network node agents.

In some aspects, the data for the set of device and network node agents comprises one or more of: the cost of the at least one training device being connected to the at least one NTN; the cost of the at least one training device being connected to the at least one TN; the service and application usage time by the at least one training device within a next time interval (T); the throughput and latency requirements of a predicted service in the at least one training device; and the conditions of at least one of the networks available to the at least one training device.

In some aspects, the attribute information for the cost of the at least one connected device for training being connected to the at least one NTN comprises one or more of: the previous cost of service for all available NTNs; the time when the previous service occurred; and the total power consumption of the at least one connected device for training and the at least one NTN during service.

In some aspects, the attribute information for the cost of the at least one connected device for training being connected to the at least one TN comprises one or more of: the previous cost of service for all available TNs; the time when the previous service occurred; and the total power consumption of the at least one connected device for training and the at least one TN during service.

In some aspects, the attribute information for the service and application usage time by the at least connected device for training within the next time interval (T) comprises one or more of: the type of service being used in the at least one training device; the time of usage; and the historical behavior of users of the at least one training device.

In some aspects, the attribute information for the throughput and latency requirements of the predicted service in the at least one connected device for training comprises one or more of: the location of the at least one connected device for training; the speed at which the at least connected device for training is moving; and the historical mobility trajectory of the at least connected device for training.

In some aspects, the attribute information for the conditions of the at least one of the networks available to the at least connected device for training comprises one or more of: the proximity of all potential satellites in the at least one network; the available radio network deployment topology from the at least one network's knowledge base; the propagation conditions of the at least one network; the downlink signal-to-interference-plus-noise ratio as a function of time for the at least one network; the system load on the at least one network; the number of radio link failure (RLF) events in the at least one network; the historical and current handover failure (HOF) events in the at least one network; the historical and current ping-pong rate in the at least one network; the historical average time in outage of the at least one network; the predicted coverage of the at least one network's TN's per time slot; the historical availability of TNs and NTNs in the at least one network; the availability of TNs and NTNs in the at least one network in the past per timeslot at a given geo-location and predicted availability in a plurality of future time intervals; and the current and previous TN names and NTN names and elevations in the at least one network.

In some aspects, the collected data further includes data collected by a collaborative machine learning method. In some aspects, the collaborative machine learning method is a federated learning method.

In some aspects, the graph-based ML models are generated according to:
Gᵢ(Aᵢ, Fᵢ)
   where:
      Aᵢ refers to an adjacency matrix (nxn), in the case of n nodes, where nε{NTN, TN, UE}, and
      Fᵢ is the feature vector for graph i.

In some aspects, the source station is a non-terrestrial network (NTN).

In some aspects, the one or more candidate target cells are terrestrial networks (TNs).

In some aspects, the connected device is a user equipment (UE).

In some aspects, the at least one or more CHO commands includes at least one of: a leaving condition, a target cell identity (ID), a life timer, a CHO command priority, and a CHO command ID.

According to a second aspect, a connected device is provided, the device comprising processing circuitry; and a memory, said memory containing instructions executable by said processing circuitry, whereby said connected device is operative to perform the method of any one of the previously disclosed aspects.

According to a third aspect, a connected device is provided, wherein the connected device is adapted to perform the method of any one of the previously disclosed aspects.

In some aspects, the connected device is a user equipment (UE).

In some aspects, the connected device is any device selected from a group consisting of: a sensor, a ground vehicle, an aircraft, or a watercraft, wherein the selected device has connectivity capabilities to both terrestrial and non-terrestrial networks.

According to a third aspect, a computer program comprising instructions for adapting an apparatus to perform the method of any one of the previously disclosed aspects is provided.

According to a fourth aspect, a carrier containing the computer program previously disclosed, wherein the carrier is one of an electronic signal, optical signal, radio signal, or compute readable storage medium, is provided.

In some aspects, t the graph-based ML models are graph neural networks.

### BRIEF DESCRIPTION OF THE DRAWINGS

The accompanying drawings, which are incorporated herein and form part of the specification, illustrate various aspects.

FIG. 1 is a sequence diagram illustrating a conventional handover (HO) procedure for 5G New Radio (NR) communications in LEO-based Non-Terrestrial Networks (NTN).

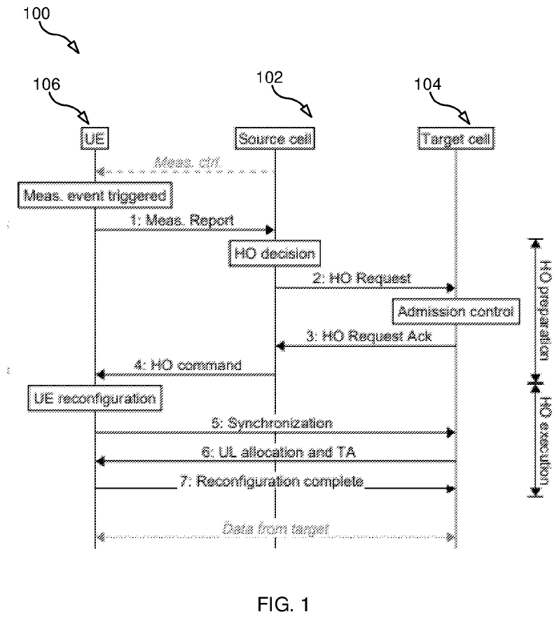

FIG. 2 is a block diagram illustrating a method for a machine learning (ML) assisted conditional handover (CHO) procedure for a connected device as disclosed in some aspects.

FIG. 3 is a block diagram illustrating a computer-implemented method for building a machine learning (ML) model for assisting in conditional handover (CHO) procedures as disclosed in some aspects.

FIG. 4 is a block diagram illustrating a sequence of prediction models as disclosed in some aspects.

FIG. 5 is a table illustrating a list of features from a non-terrestrial network (NTN), terrestrial network (TN), and a user equipment (UE) as disclosed in some aspects.

FIG. 6 illustrates a graph structure between NTN, TN, and UE as disclosed in some aspects.

FIG. 7 is a sequence of graphs and tables illustrating node and edge generation as disclosed in some aspects.

FIG. 8 is a graph illustrating a time varying graph structure of network elements as disclosed in some aspects.

FIG. 9 is a sequence diagram illustrating the generation of a prediction and connectivity graph before a CHO request is initiated as disclosed in some aspects.

FIG. 10 is a sequence diagram illustrating packet forwarding prior to the execution of a HO command as disclosed in some aspects as disclosed in some aspects.

FIG. 11 is a sequence diagram illustrating the generation of the connectivity graph using a selected federation model as disclosed in some aspects.

FIG. 12 is a sequence diagram illustrating tasks that need to be performed periodically to generate an ML training model as disclosed in some aspects.

FIG. 13 is a block diagram of an apparatus according to some embodiments.

FIG. 14 is a block diagram of an apparatus according to some embodiments.

### DETAILED DESCRIPTION

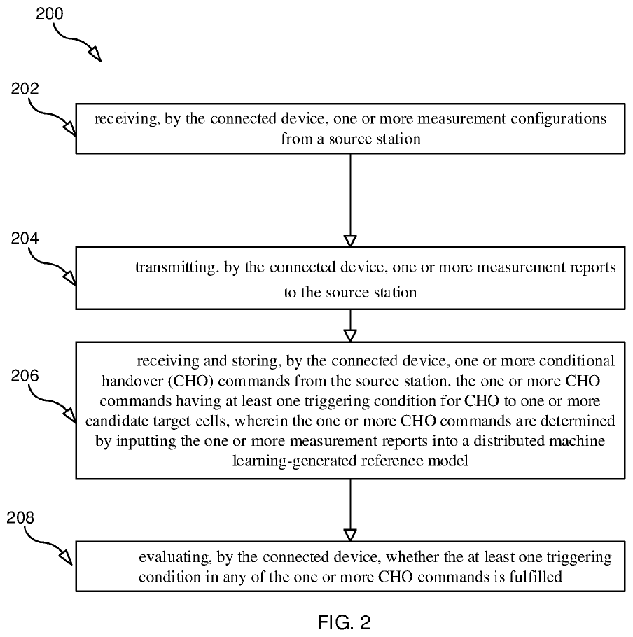

FIG. 2 is a block diagram illustrating a method 200 for a distributed machine learning (ML) assisted conditional handover (CHO) procedure for a connected device. In some aspects, the method 200 comprises a first step 202 of receiving, by the connected device, one or more measurement configurations from a source station. In some aspects, this is a non-terrestrial network. In others, this may be a terrestrial network. In some aspects, the method 200 comprises a second step 204 of transmitting, by the connected device, one or more measurement reports to the source station. In some aspects, the method 200 comprises a third step 206 of receiving and storing, by the connected device, one or more conditional handover (CHO) commands from the source station, the one or more CHO commands having at least one triggering condition for CHO to one or more candidate target cells, wherein the one or more CHO commands are determined by inputting the one or more measurement reports into a machine learning-generated reference model. In some aspects, the method 200 further comprises evaluating, by the connected device, whether the at least one triggering condition in any of the one or more CHO commands is fulfilled.

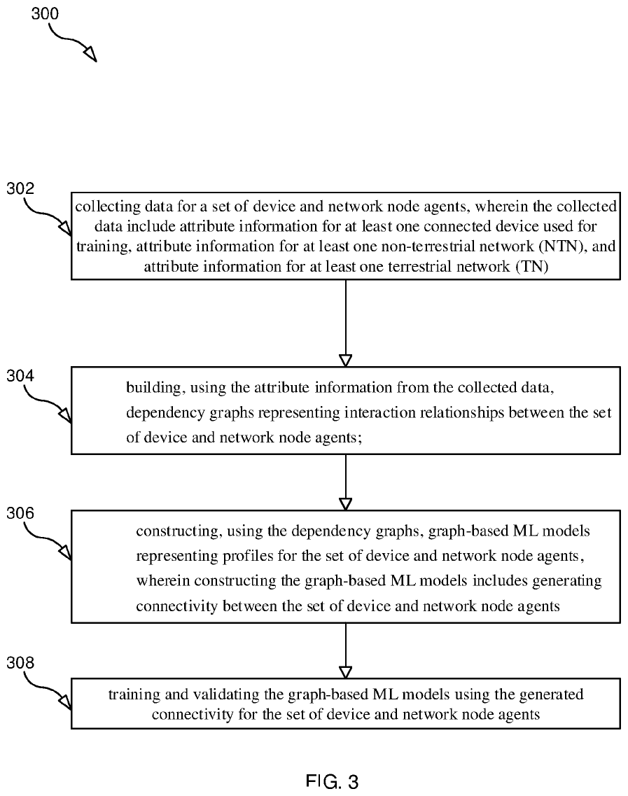

FIG. 3 is a block diagram illustrating a method 300 for generating a distributed machine-learning (ML) reference model. In some aspects, the first step 302 of the method 300 comprises collecting data for a set of device and network node agents. In some aspects, the collected data include attribute information for at least one connected device used for training, attribute information for at least one non-terrestrial network (NTN), and attribute information for at least one terrestrial network (TN). In other aspects, the second step 304 comprises building, using the attribute information from the collected data, dependency graphs representing interaction relationships between the set of device and network node agents. In other aspects, the third step 306 comprises constructing, using the dependency graphs, graph-based ML models representing profiles for the set of device and network node agents, wherein constructing the graph-based ML models includes generating connectivity between the set of device and network node agents. In other aspects, the fourth step 308 comprises training and validating the graph-based ML models using the generated connectivity for the set of device and network node agents.

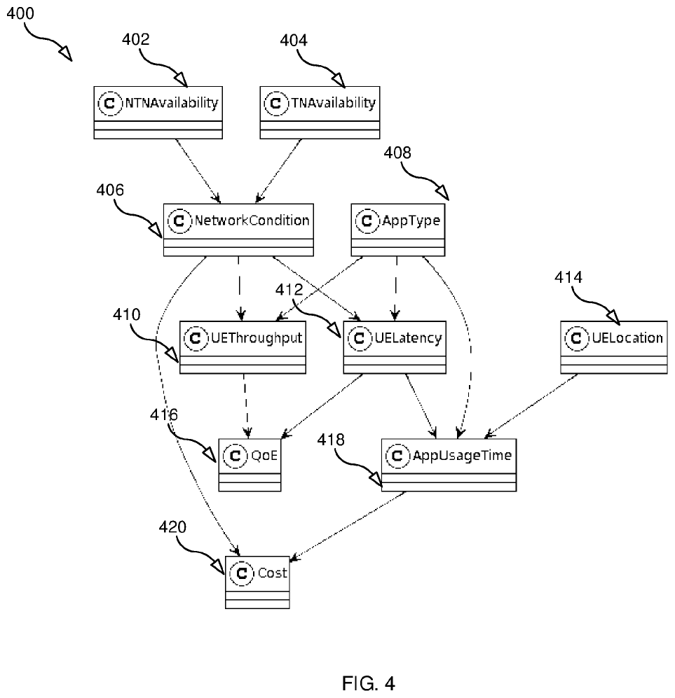

FIG. 4 illustrates a connectivity graph 400 for a set of device and network node agents. The connectivity graph 400 indicates sequence relationships between the set of device and network node agents. In some aspects, the availability of non-terrestrial networks (NTNs) 402 and the availability of terrestrial networks (TNs) 404 sequences into the condition of the network 406. Furthermore, in some aspects, the condition of the network 406 sequences into the UE throughput 410. In other aspects, the type of application being used by a user equipment (UE) 408 sequences into the throughput of the UE 410, the latency of the UE 412, and the app usage time 418. In other aspects, the UE throughput 410 sequences into the quality of experience (QoE) 416. In other aspects, the location of the UE 414 sequences into the usage time of the application. In other aspects, the condition of the network 406 and the usage time of the app sequence into total cost 420. In other aspects, meta data may be used as an input to the set of device and network node agents, such as in instances where the location of the device or network node can be deterministic. In summary, the sequence diagrams shown in the connectivity graph 400 all interact with each other and comprise multiple dependencies.

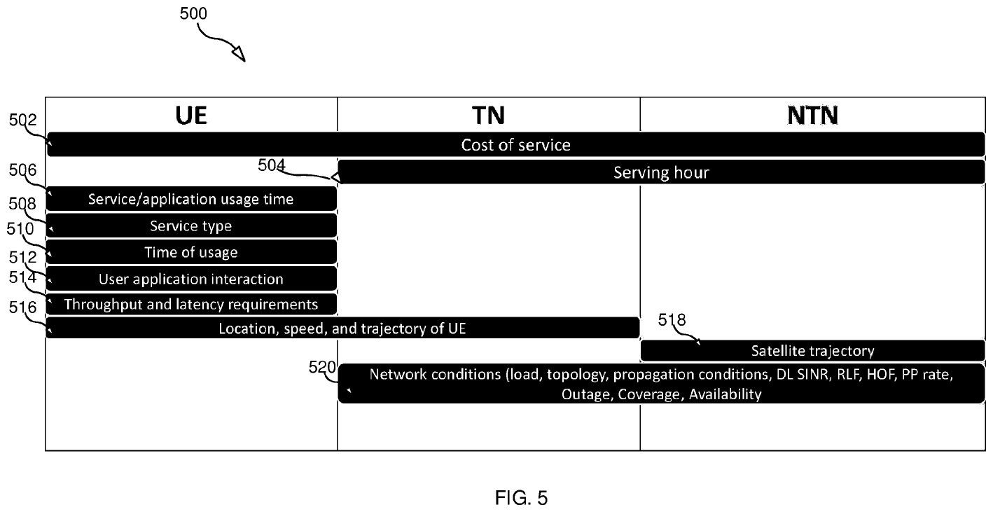

FIG. 5 is a block diagram 500 illustrating a list of features from a user equipment (UE), non-terrestrial network (NTN), and terrestrial network (TN). Some of the features are shared, while others are local. For example, cost of service 502 is shared between all of the elements, while serving hour 504 is shared between only TN and NTN, and service/application usage time 506 is specific to the UE and is not shared. Due to the distributed nature of the feature space in between network nodes and UE, the goal is to train a model such that minimum UE application/service requirement must be met by the underlying KPI's measured in the network nodes. This way, the aspects disclosed herein guarantee that the application service quality remains bounded.

In some aspects, the following relationships exist between the various sequence graphs and features shown in FIGS. 4 and 5:
minUE(throughput)|applicationUE≤fTN,NTN (SINR, RLF, HOF, PP rate, . . . )
maxUE (latency)|applicationUE≤fTN,NTN (SINR, RLF, HOF, PP rate, . . . )
usage timeUE|applicationUE≤Coverage and Availability time NTN, +Coverage and Availability time TN,
min(cost) where cost=f (serving bandwidthUE, serving timeUE, energy consumptiontotal)

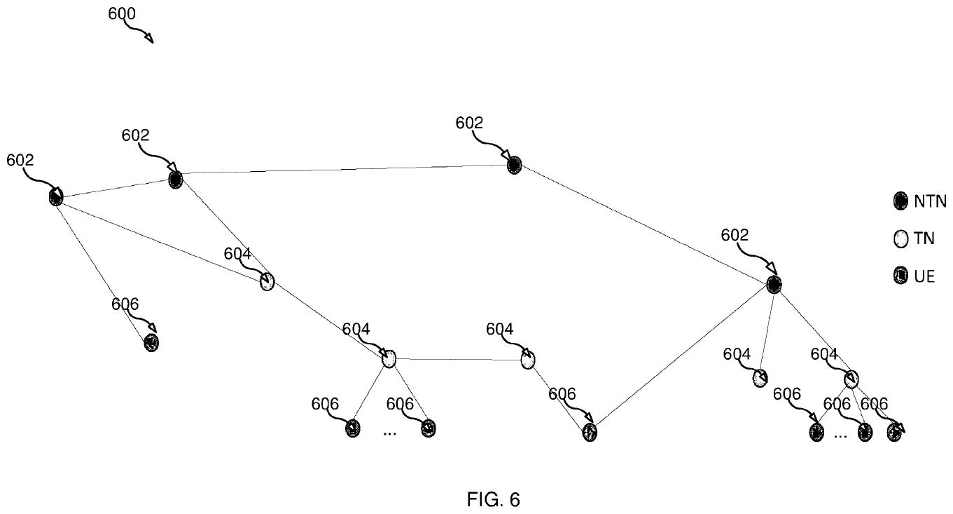

FIG. 6 illustrates a snapshot graph structure 600 obtained between an NTN (nodes 602), a TN (nodes 604), and a UE (nodes 606). Here the network nodes NTN, TN and UE are assumed to be interconnected, hence can be implemented in the form of graph structure. NTN, TN and UE's are individual nodes (n) of local graphs where they have features. The embedded representations of the nodes are then shared in between nodes to train jointly a higher level ML model with graph neural networks (GNN).

In some aspects, an adjacency matrix may be represented by:
Gᵢ (Aᵢ,Fᵢ). Aᵢ: adjacency matrix (nxn) in the case of n nodes where ne {NTN, TN, UE}. Fᵢ is the feature vector for graph i.

### Decision Making:

Depending on the results of the predicted models and also the UE requirements in time and space, scheduling of UE's to the right network nodes (TN or NTN) can be made using the graph neural network (GNN) algorithm. The ML model needs to be formulated such that the output of the model is the decision to handover or not rather while the intermediate results from predictions are used along the final decision.

### Graph Generation:

In some aspects, a topology (connectivity) graph is generated given the conditions. The conditions are a function of multiple models that each consists of various application, radio, network and energy metrics as mentioned previously in this disclosure. The goal here is to generate realistic connectivity graphs between UE and the candidate network nodes that the UE will be connected to. One candidate technique is GraphRNN which is used in drug discovery use cases, for example. The same technique can either build a generation from scratch or complete an incomplete graph (e.g., in the cases the UE is aware of only a subset of nodes but would like to have alternative nodes as well, in that case graph completion can be performed).

In some aspects, the graph is represented by the adjacency matrix previously disclosed, and the space complexity of adjacency matrix is O(n2). Since the candidate network nodes that the graph would involve/generate is not expected to be high (e.g., 4-5 nodes max.), space complexity in our use case might not be a big issue. However, the order of the graph is important which will be constructed with the ranking information, hence the problem might rise with a O(N!) time complexity. Again, due to not large N, this is not foreseen as a major issue. Graph generation includes two main steps: i) obtain the distribution of the dataset; ii) draw samples from the obtained distribution so that the drawn samples will be as similar as the generated samples by a learned model (parameterized by theta). So the goal is to learn the parameters theta of the generative model (e.g., GraphRNN). In some aspects, the goal is to maximize the likelihood that the aspects disclosed herein can take the average of argmax, hence the role of E. In some aspects, this relationship can be expressed by the formula:

Q*=argmaxQ Ex˜pdata log pmodel(X|Q)

The training phase comprises many graphs that the model learns from, and in the inference phase it is asked to generate graphs with given conditions. Since the above equation assumes a IID (identical and independent distribution) of data samples, and since some connectivity graph sets might be very different than others in reality based on geographical location and availability and network conditions, this disclosure proposes group federation where the graphs are separated into groups based on their similarity.

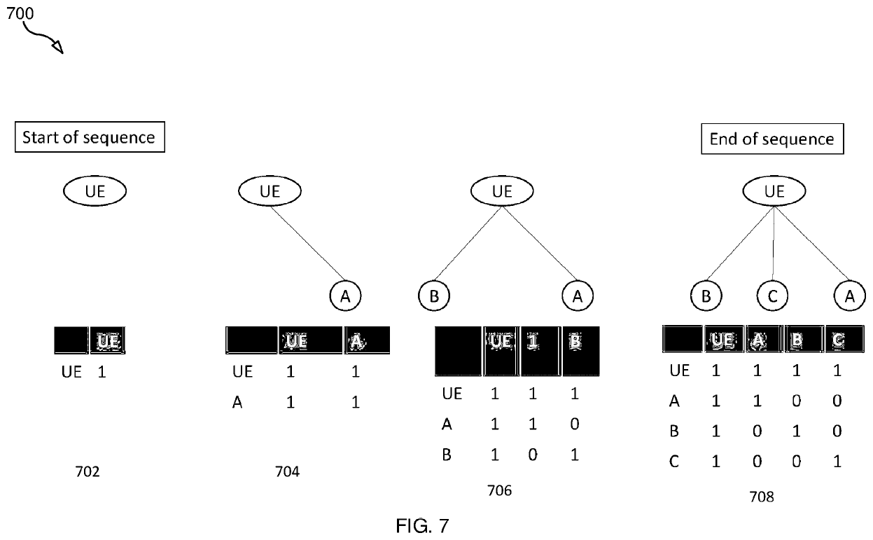

FIG. 7 illustrates a sequence generation 700 for a set of nodes with a UE node and target nodes. The steps comprise adding a node followed by adding an edge until the end of the sequence. Each sequence step is illustrated (702, 704, 706, 708) showing an additional node and edge being added. During the training phase, the order of the nodes is obtained from the ranking (that yields the highest QoE towards lowest overall QoE). If UE is expected to yield the highest QoE by connecting to node 1, the ranking of it will be the highest, then followed by node 3 and then node 2 (according to FIG. 7). Eventually what is being minimized is the loss, L as in any ML model optimization:

$$L = - [ y {1}^{′} log y + ( 1 - y {1}^{*} ) log ( 1 - y 1 ) ]$$

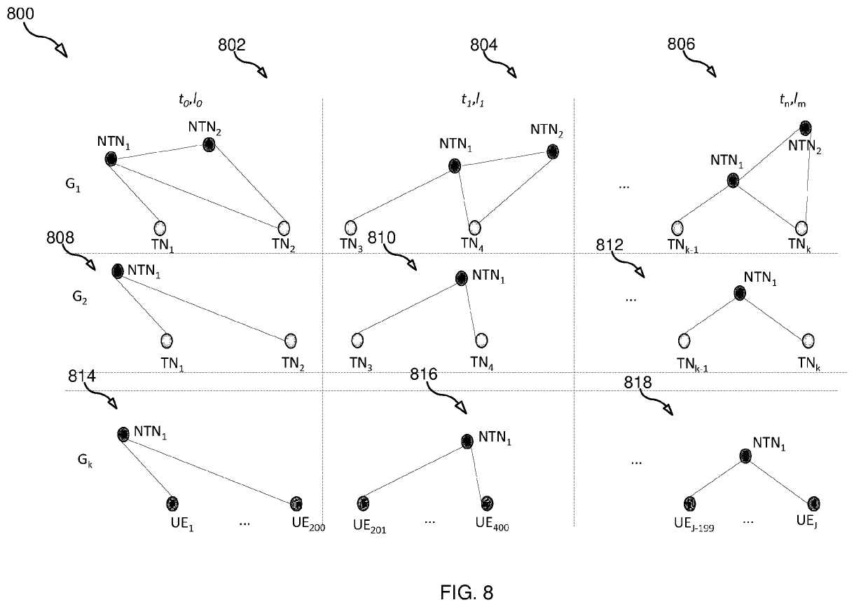

FIG. 8 is a time varying graph structure 800 of network elements, illustrating, as in one aspect, a collaborative machine learning method, such as federated learning, on GraphRNN. The graph structure (the topology) is not static, but rather repetitive between NTN's and TN's as the NTN to TN connection repeats itself periodically depending on the orbit of the satellites, assuming that the TN's have no mobility and rather at fixed positions. This can be seen in the nodes generated for Gᵢ at time 0 and location 0 (t₀, l₀) 802, time 1 and location 1 (t₁, l₁) 804, and time n and location n (tₙ, lₙ) 806. This is then repeated at G₂ for 808, 810, and 812, and continues on until Gₖ, for 814, 816, and 818. Therefore, as the NTN's orbit, they might build similar graph structure (topology) with other TN's as they travel through their orbit at different times hence passing the message learned from temporarily disconnected nodes and UE's enabling collaborative learning. Therefore, the information that is being learned from one graph at time t₁ in location l₁, can be useful for t₂ in location l₂, given that the graph structure obtained in t₁ and t₂ are similar. This means that the learned knowledge (trained graph model) can be reused in other geo-positions.

In another aspect, federated learning is utilized (also in the form of federation of graph models) so that the UE's record historical events are shared by means of local (UE) trained updates so that the HO decision uses experience information on previous handovers. As this information is sensitive, a federated learning method can be implemented where only the learned model weights are shared in between rather than the raw GPS data. Just before UE decides, the local model weights are updated, so that the estimation for the TN location is performed via the federated ML model. If the model does not estimate a nearby TN, the measurement should not be performed hence a NTN-to-NTN handover is initiated instead.

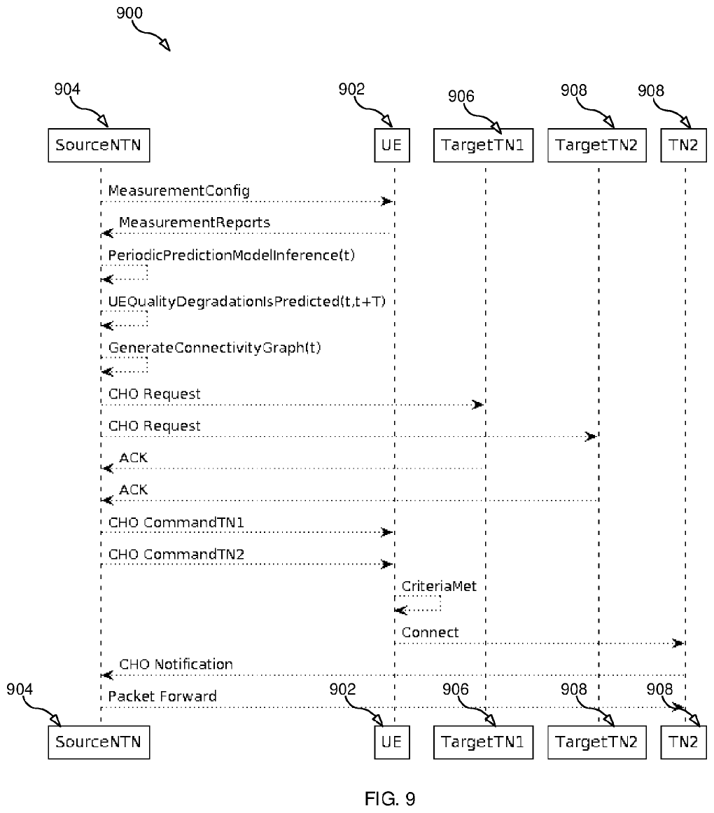

FIGS. 9-13 illustrate sequence diagrams. These sequence diagrams show various aspects of the conditional handover (CHO) procedure as assisted by a distributed ML-generated reference model in accordance with exemplary embodiments disclosed herein.

FIG. 9 illustrates a sequence 900 wherein, in some aspects, a user equipment (UE) 902 receives measurement configurations from a source non-terrestrial network (NTN) 904 and sends measurement reports to the NTN 904. A series of calculations then occurs at the source NTN 904 based on a previously generated connectivity model, including a periodic prediction model inference, a UE quality degradation prediction, and a connectivity graph is generated for the current sequence. The source NTN 904 then sends a conditional handover (CHO) request to a target terrestrial network (TN1) 906 and a target TN2 908, each of which then sends acknowledgement to the source NTN 904. The source NTN 904 then sends CHO commands for the terrestrial networks 906, 908 to the UE 902, which then determines whether the criteria for handover are met by either. The UE then initiates connectivity with a target network, which, in this aspect, is TN2 908. TN2 908 then notifies the Source NTN 904, which forwards the packet to the TN2 908.

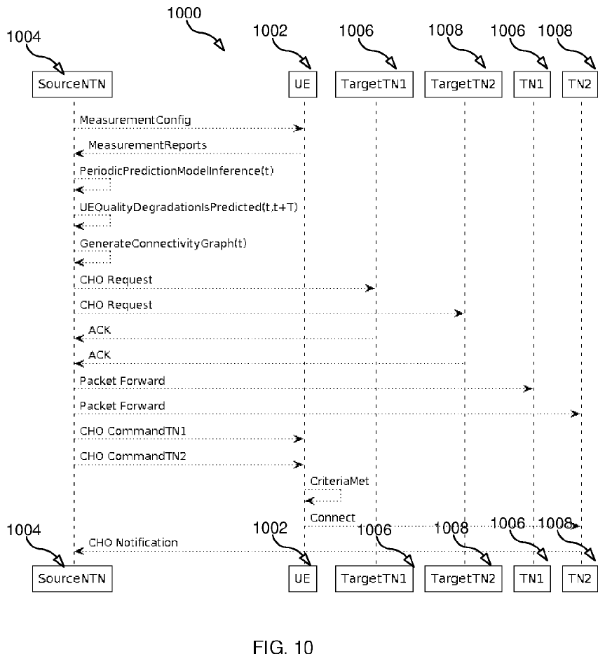

FIG. 10 illustrates a sequence 1000 wherein, in some aspects, a UE 1002 receives measurement configuration from a source NTN 1004 and sends measurement reports to the source NTN 1004. Unlike in the previous aspect shown in FIG. 9, however, the aspect in FIG. 10 shows a packet forwarded before the handover command is executed, which enables seamless handover from source 1004 to destination (in this aspect, TN2 1008). This aspect is useful in the case that there may be a problem delivering the CHO notification. As in FIG. 9, in FIG. 10, according to some aspects, a series of calculations then occurs at the source NTN 1004 based on a previously generated connectivity model, including a periodic prediction model inference, a UE quality degradation prediction, and a connectivity graph is generated for the current sequence. The source NTN 1004 then sends a conditional handover (CHO) request to a target terrestrial network (TN1) 1006 and a target TN2 1008, each of which then sends acknowledgement to the source NTN 1004. The source NTN 1004, as previously discussed, then forwards packets to TN1 1006 and TN2 1008. The source NTN 1004 then sends CHO commands for the terrestrial networks 1006, 1008 to the UE 1002, which then determines whether the criteria for handover are met by either. The UE then initiates connectivity with a target network, which, in this aspect, is TN2 1008. TN2 1008 then notifies the source NTN 1004.

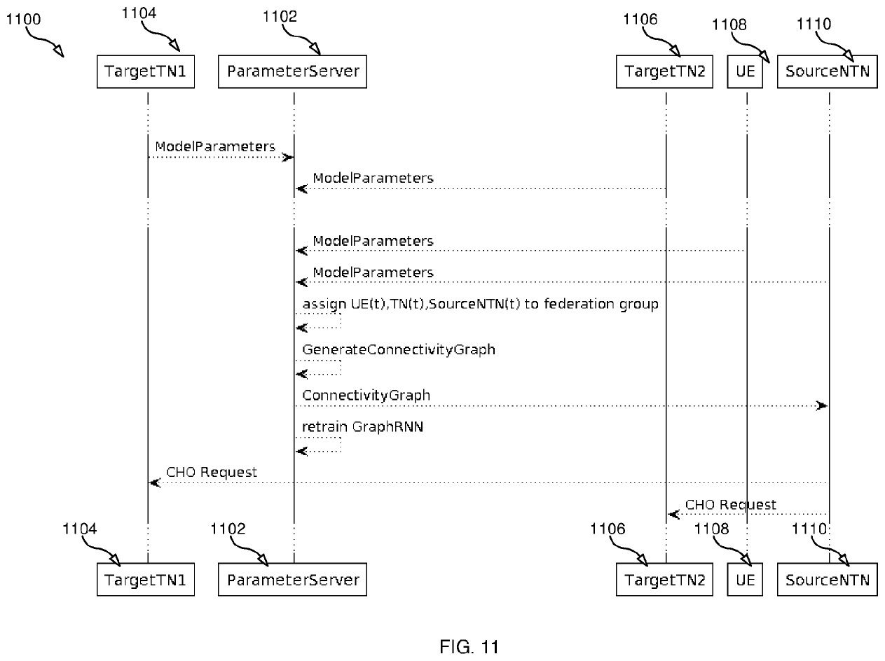

FIG. 11 illustrates a sequence diagram 1100 showing model parameters that are learned with respect to prediction models in every network element that are shared with a parameter server 1102. The parameter server 1102 then selects the GraphRNN federation group and generates a connectivity graph using the selected federation model. In some aspects, a target TN1 1104 forwards model parameters to a parameter server 1102, as does a target TN2 1106. Further, in some aspects, a UE 1108 and source NTN 1110 forward model parameters to a parameter server 1102. A series of calculations are performed at the parameter server 1102 in order to generate a connectivity graph, send the connectivity graph to a source NTN 1110, and then retrain the graphRNN. After the graphRNN has been retrained, a CHO request is sent from the source NTN 1110 to the target TN1 1104 and the target TN2 1106.

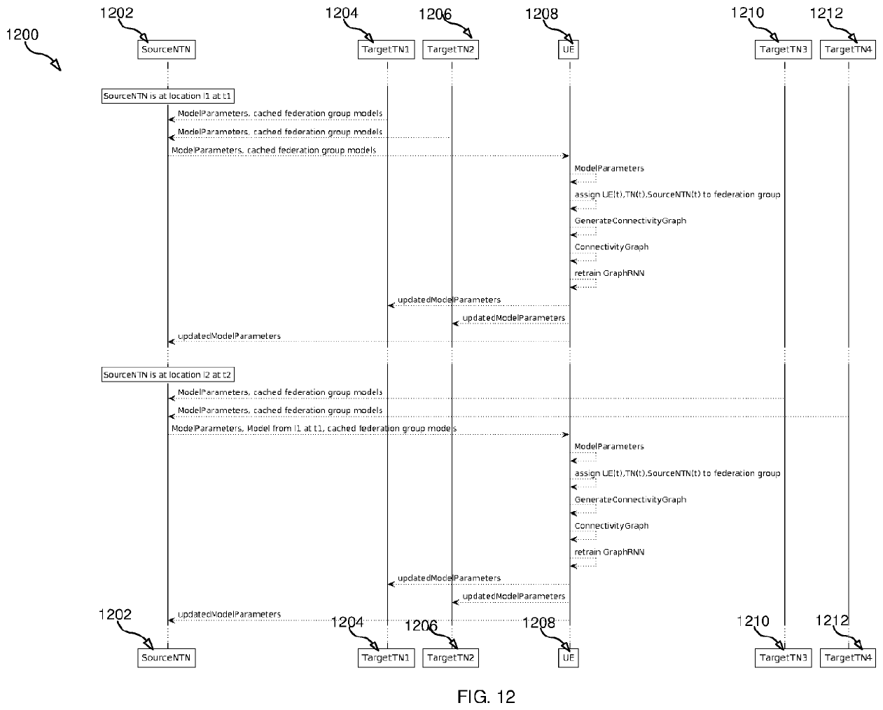

FIG. 12 illustrates a sequence diagram 1200 that depicts the tasks needed to be performed periodically as a satellite (source NTN 1202) orbits, which can carry a model to other locations at different points in time. Essentially, in some aspects, FIG. 12 illustrates the steps needed to be performed to generate an ML-model using federated learning, when the source NTN 1202 is at different locations. In some aspects, when source NTN 1202 is at a location 1 (l1) at time 1 (t1), model parameters are sent to the source NTN 1202 from target networks TN1 and Tn2, 1204, 1206. In other aspects, when source NTN 1202 is at location 2 (l2) at time 2 (t2), model parameters are sent to the source NTN 1202 from target networks TN3 and TN4 1210, 1212. At either location and time, the source NTN 1202 then sends model parameters to a UE 1208, at which a series of calculations are performed to generate a connectivity graph and retrain graphRNN. The UE 1208 then sends updated model parameters the targets TN1, TN2 1204, 1206. It additionally sends updated model parameters to the source NTN 1202 at either time and location. This process is repeated, in some aspects, across a variety of locations and times with a variety of target networks for a source NTN 1202. In this way, the ML model may be trained using federated learning, according to some aspects.

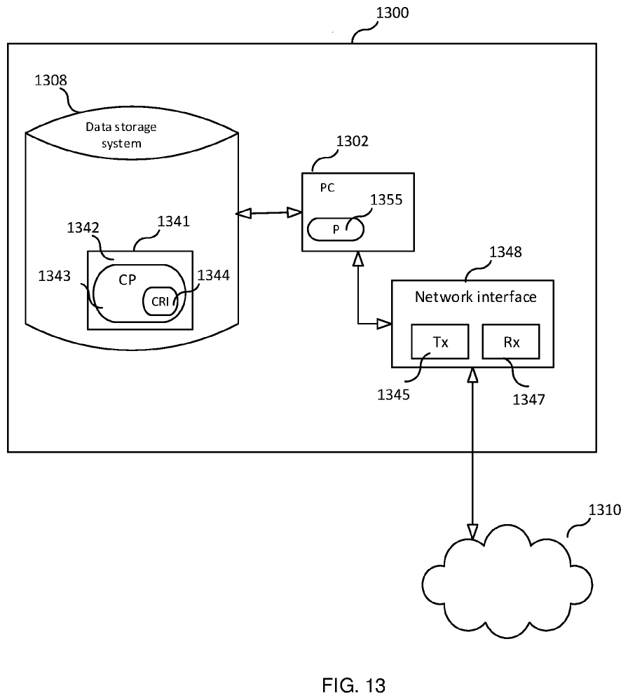

FIG. 13 is a block diagram of an apparatus 1300 (e.g., a connected device), according to some aspects. As shown in FIG. 13, the apparatus may comprise: processing circuitry (PC) 1302, which may include one or more processors (P) 1355 (e.g., a general purpose microprocessor and/or one or more other processors, such as an application specific integrated circuit (ASIC), field-programmable gate arrays (FPGAs), and the like); a network interface 1348 comprising a transmitter (Tx) 1345 and a receiver (Rx) 1347 for enabling the apparatus to transmit data to and receive data from other computing devices connected to a network 1310 (e.g., an Internet Protocol (IP) network) to which network interface 1348 is connected; and a local storage unit (a.k.a., “data storage system”) 1308, which may include one or more non-volatile storage devices and/or one or more volatile storage devices. In aspects where PC 1302 includes a programmable processor, a computer program product (CPP) 1341 may be provided. CPP 1341 includes a computer readable medium (CRM) 1342 storing a computer program (CP) 1343 comprising computer readable instructions (CRI) 1344. CRM 1342 may be a non-transitory computer readable medium, such as, magnetic media (e.g., a hard disk), optical media, memory devices (e.g., random access memory, flash memory), and the like. In some aspects, the CRI 1344 of computer program 1343 is configured such that when executed by PC 1302, the CRI causes the apparatus to perform steps described herein (e.g., steps described herein with reference to the flow charts). In other aspects, the apparatus may be configured to perform steps described herein without the need for code. That is, for example, PC 1302 may consist merely of one or more ASICs. Hence, the features of the aspects described herein may be implemented in hardware and/or software.

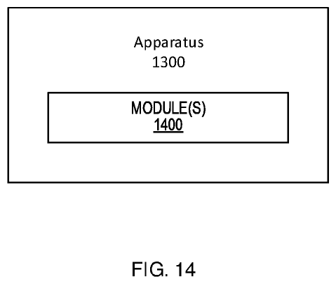

FIG. 14 is a schematic block diagram of the apparatus 1300 according to some other aspects. The apparatus 1300 includes one or more modules 1400, each of which is implemented in software. The module(s) 1400 provide the functionality of apparatus 1300 described herein (e.g., the steps herein).

While various aspects of the present disclosure are described herein, it should be understood that they have been presented by way of example only, and not limitation. Thus, the breadth and scope of the present disclosure should not be limited by any of the above-described exemplary aspects. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for a distributed machine learning assisted conditional handover procedure for a connected device, the method comprising:
receiving, by the connected device, one or more measurement configurations from a source station;
transmitting, by the connected device, one or more measurement reports to the source station;
receiving and storing, by the connected device, one or more CHO commands from the source station, the one or more CHO commands having at least one triggering condition for CHO to one or more candidate target cells,
wherein the one or more CHO commands are determined by inputting the one or more measurement reports into a distributed ML-generated reference model; and
evaluating, by the connected device, whether the at least one triggering condition in any of the one or more CHO commands is fulfilled.

2. The method of claim 1, further comprising executing, by the connected device, a decision for handover based on the evaluation,
wherein the connected device executes the handover if the one or more CHO commands is fulfilled and does not execute the handover if the one or more CHO commands is not fulfilled.

3. The method of claim 1, wherein the distributed ML-generated reference model is generated by:
collecting data for a set of device and network node agents,
wherein the collected data include attribute information for at least one connected device used for training, attribute information for at least one non-terrestrial network, and attribute information for at least one terrestrial network;
building, using the attribute information from the collected data, dependency graphs representing interaction relationships between the set of device and network node agents;
constructing, using the dependency graphs, graph-based ML models representing profiles for the set of device and network node agents,
wherein constructing the graph-based ML models includes generating connectivity between the set of device and network node agents; and
training and validating the graph-based ML models using the generated connectivity for the set of device and network node agents.

4. The method of claim 3, wherein the data for the set of device and network node agents comprises one or more of:
the cost of the at least one training device being connected to the at least one NTN;
the cost of the at least one training device being connected to the at least one TN;
the service and application usage time by the at least one training device within a next time interval;
the throughput and latency requirements of a predicted service in the at least one training device; and
the conditions of at least one of the networks available to the at least one training device.

5. The method of claim 4, wherein the attribute information for the cost of the at least one connected device for training being connected to the at least one NTN comprises one or more of:
the previous cost of service for all available NTNs;
the time when the previous service occurred; and
the total power consumption of the at least one connected device for training and the at least one NTN during service.

6. The method of claim 4, wherein the attribute information for the cost of the at least one connected device for training being connected to the at least one TN comprises one or more of:
the previous cost of service for all available TNs;
the time when the previous service occurred; and
the total power consumption of the at least one connected device for training and the at least one TN during service.

7. The method of claim 4, wherein the attribute information for the service and application usage time by the at least one connected device for training within the next time interval comprises one or more of:
the type of service being used in the at least one training device;
the time of usage; and
the historical behavior of users of the at least one training device.

8. The method of claim 4, wherein the attribute information for the throughput and latency requirements of the predicted service in the at least one connected device for training comprises one or more of:
the location of the at least one connected device for training;
the speed at which the at least one connected device for training is moving; and
the historical mobility trajectory of the at least one connected device for training.

9. The method of claim 4, wherein the attribute information for the conditions of the at least one of the networks available to the at least connected device for training comprises one or more of:
the proximity of all potential satellites in the at least one network;
the available radio network deployment topology from the at least one network's knowledge base;
the propagation conditions of the at least one network;
the downlink signal-to-interference-plus-noise ratio as a function of time for the at least one network;
the system load on the at least one network;
the number of radio link failure events in the at least one network;
the historical and current handover failure events in the at least one network;
the historical and current ping-pong rate in the at least one network;
the historical average time in outage of the at least one network;
the predicted coverage of the at least one network's TN's per time slot;
the historical availability of TNs and NTNs in the at least one network;
the availability of TNs and NTNs in the at least one network in the past per timeslot at a given geo-location and predicted availability in a plurality of future time intervals; and
the current and previous TN names and NTN names and elevations in the at least one network.

10. The method of claim 3, wherein the collected data further include data collected by a collaborative machine learning method.

11. The method of claim 3, wherein the graph-based ML models are generated according to:
Gi(Ai, Fi)
where:
Ai refers to an adjacency matrix, in the case of n nodes, where nε{NTN, TN, UE}, and
Fi is the feature vector for graph i.

12. The method of claim 1, wherein the source station is a non-terrestrial network.

13. The method of claim 1, wherein the one or more candidate target cells are terrestrial networks.

14. The method of claim 1, wherein the connected device is a user equipment.

15. The method of claim 1, wherein the at least one or more CHO commands includes at least one of:
a leaving condition,
a target cell identity,
a life timer,
a CHO command priority, and
a CHO command ID.

16. A connected device comprising:
processing circuitry; and
a memory, said memory containing instructions executable by said processing circuitry, whereby said connected device is operative to perform the method of claim 1.

17. (canceled)

18. The connected device of claim 16, wherein the connected device is a user equipment.

19. The connected device of claim 16, wherein the connected device is any device selected from a group consisting of: a sensor, a ground vehicle, an aircraft, or a watercraft, wherein the selected device has connectivity capabilities to both terrestrial and non-terrestrial networks.

20. A computer program product comprising a non-transitory computer readable medium storing a computer program comprising instructions for adapting an apparatus to perform the method of claim 1.

21. A computer program product comprising a non-transitory computer readable storage medium storing a computer program comprising instructions which, when executed on processing circuitry, cause the processing circuitry to carry out the method according to claim 1.

22-23. (canceled)
